(19) United States
(12) Patent Application Publication
(10) Pub. No.: US 2010/0057674 A1
(43) Pub. Date: Mar. 4, 2010

(54) FLOATING LICENSES FOR A REAL TIME LICENSE SYSTEM

(75) Inventor: James F. O'Donnell, Camillus, NY (US)

Correspondence Address: HONEYWELL INTERNATIONAL INC.;PATENT SERVICES, 101 COLUMBIA ROAD, P O BOX 2245, MORRISTOWN, NJ, 07962-2245, US

(73) Assignee: Honeywell International, Inc., Morristown, NJ (US)

(21) Appl. No.: 12/199,003

(22) Filed: Aug. 27, 2008

(51) Int. Cl. G06F 7/00; G06F 15/16; H04L 9/32; G06F 17/30

(52) U.S. Cl. 707/3; 709/203; 726/28; 707/E17.044

(57) ABSTRACT

A license management system, including a license server to store and manage at least one license, each license corresponding to one or more software features; a portable client device to request a temporary license from the server corresponding to one or more of the at least one license so as to enable operation of the one or more software features corresponding to the temporary license. The temporary license includes an expiration condition defining conditions under which the temporary license will expire.

### BACKGROUND OF THE INVENTION

Data collection devices are a class of device used to collect, process, and transfer data to a data processing system. Data collection devices may be provisioned with one or more of a variety of data collection sub-systems including: imager, laser scanner, RFID scanner, and magnetic media scanner. Such sub-systems generally scan some data bearing device such as dataforms (e.g., barcodes), magnetic stripes, and RFID tags. The collected data is processed within the data collection device by a processor and associated circuits. The type and amount of processing may vary depending on the class of device, but usually includes, at a minimum, decoding the output of the data collection sub-system to generate a string of data corresponding to the encoded data contained within the data bearing device. The decoded data is then generally transferred using any number of wired and wireless communication paths, such as 802.11, cellular, IrDA, USB, serial and parallel paths.

Generally, data collection devices can be thought of as falling into three classes: fixed, mobile, and handheld. Fixed devices are generally incorporated into stationary objects such as point of sale systems (examples include transaction terminals and image kiosks) and walls (examples include RFID tracking devices). Mobile devices generally have similar electronic configurations to fixed devices, but are mechanically designed to be mounted on movable objects, such as carts and fork lifts. Finally, hand held devices are designed to be carried around by a user. Popular categories of hand held data collection devices include portable data terminals (PDTs), transaction terminals, image kiosks, and hand held bar code scanners. All of these devices generally have a wide variety of software applications included, to implement the functionality of the various hardware components (e.g., scanning, tracking, data entry/manipulation, etc.) and to provide additional functionality to the data collection devices. Each of these software features may require one or more software licenses in order to operate.

Software licenses are used to control the use of software installed on computing devices. Historically, software licenses were tied to the particular computer running the software under license. This arrangement was suitable in situations involving a small number of licenses or computer programs. However, in larger settings, such as large corporate settings, which may have a large number of licenses for a variety of different programs, tying licenses to particular computers is inefficient and difficult to manage.

License servers were developed to simplify the process of managing a large number of software licenses. A license server connected to the computer via a network, or a license key device attached to the computer, stores a number of licenses for a variety of programs. When a user logs onto a network, the user's computer requests a license from the license server. If a license is available, the license server transmits the license to the computer, enabling the use of the program corresponding to the license. When the user logs off or shuts down the computer, the computer notifies the server, which releases the license for use by another user. Licenses may be reserved licenses, reserved for a single user, or floating licenses, available for use by any user.

However, the addition of data collection devices and other portable devices (such as mobile phones or personal digital assistants), creates additional challenges for the conventional license server system. For example, the license server cannot be guaranteed to be in contact with the portable devices at all times, making it difficult for the license server or the portable device to determine when the license should expire. Similarly, a given portable device may be employed by multiple users, each requiring the use of different programs. Conventional licensing systems generally operate under the assumption that the same user will use the same workstation to run the same programs. In a wireless mobile environment in which data collection devices usually operate, none of these conditions may necessarily be true at any given point in time. In addition, data collection devices may have limited storage capacity and processing power, most of which should be dedicated to performing the functions of the data collection device. These limitations suggest the need for a licensing system better equipped for a wireless mobile environment.

### SUMMARY OF THE INVENTION

Aspects of the present invention provide a system and method of managing floating licenses provided to portable devices.

According to an aspect of the present invention, a license management system is provided. The license management system comprises a license server to store and manage at least one license, each license corresponding to one or more software features; a portable client device to request a temporary license from the server corresponding to one or more of the at least one license so as to enable operation of the one or more software features corresponding to the temporary license and installed on the portable client device; wherein the temporary license includes an expiration condition defining conditions under which the temporary license will expire.

According to another aspect of the present invention, a license server is provided. The license server comprises a communication unit; and a license management unit to receive a request from a portable client device for at least one temporary license, each temporary license corresponding to at least one license that enables a corresponding software feature of the portable client device, to determine if the at least one license is available, to generate the at least one temporary license if the at least one license is available, and to transmit the at least one temporary license to the portable client device via the communication unit; wherein each temporary license comprises an expiration condition specifying when the temporary license expires.

According to another aspect of the present invention, a portable client device is provided. The portable client device comprises a communication unit; at least one software feature, each software feature requiring a license in order to operate; a license storage unit to store at least one temporary license, each temporary license enabling operation of one or more of the at least one software feature; a license management unit to generate a request for the at least one temporary license, to receive the at least one temporary license from a license server, and to enable the one or more of the software features corresponding to the at least one temporary license; wherein each temporary license includes an expiration condition specifying when the temporary license expires.

According to another aspect of the present invention, a method of generating a temporary license for a portable client device is provided. The method comprises receiving a request for a temporary license from a portable client device; determining whether a temporary license is available; generating the temporary license if the temporary license is available; and transmitting the temporary license to the portable client device; wherein the temporary license includes an expiration condition specifying when the temporary license expires.

According to another aspect of the present invention, a method is provided of disabling a temporary license when an expiration condition has expired. The method comprises determining whether the expiration condition of the temporary license is satisfied, the temporary license enabling operation of at least one software feature of a portable client device; if the expiration condition of the temporary license is satisfied, deleting the temporary license from the portable client device and disabling operation of the at least one software feature; wherein the deleting of the temporary license and the disabling of the operation occur independently of a license server.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a diagram of a license system according to an embodiment of the present invention;

FIG. 2 is a diagram of a license system according to another embodiment of the present invention;

FIG. 3 is a diagram of a license server according to an embodiment of the present invention;

FIG. 4 is a diagram of a client device according to an embodiment of the present invention;

FIG. 5 is a flowchart of a process of receiving a license according to an embodiment of the present invention; and

FIG. 6 is a flowchart of a process of license expiration according to an embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

FIG. 1 shows a license system 100 according to an embodiment of the present invention. The license system includes a license server 110, a client device 120, a license database 130, a radio access point 140, and a backroom server 150. According to other aspects of the present invention, the license system 100 may include additional and/or different units. Similarly, the functionality of two or more of the above units may be integrated into a single component; for example, the functionality of the backroom server 150 and the functionality of the license server 110 may be incorporated into a single server.

The license server 110 manages the licenses in the license system 100. When the client device 120 requests a license from the license server 110, the license server 110 determines whether the license is available. If the license is available, the license server 110 acquires the license from the license database 130, generates a temporary license based on the license acquired from the license database 130, and transmits the temporary license to the client device 120 via the radio access point 140.

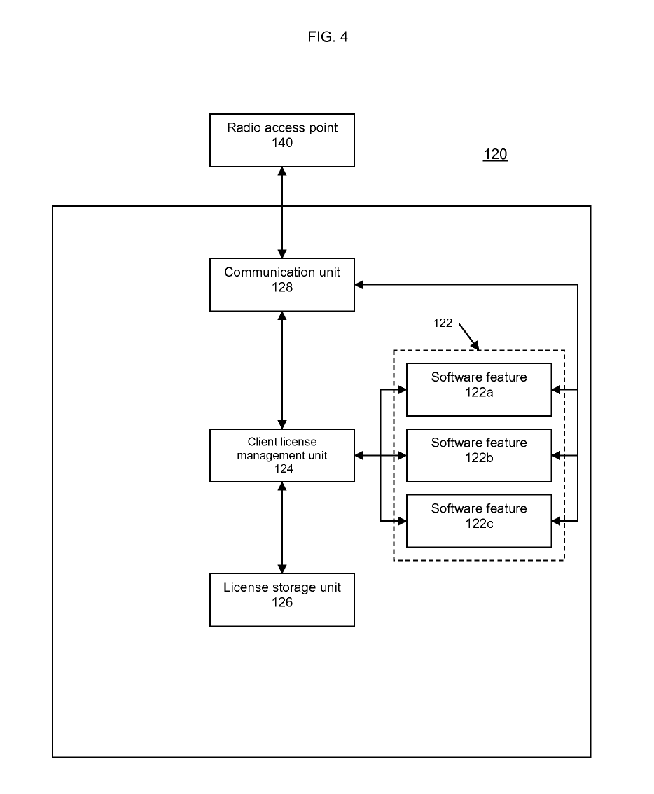

The backroom server 150 provides functionality related to various software features 122 (shown in FIG. 4) of the client device 120. The radio access point 140 communicates with the client device 120 via a wireless communication technology, such as Bluetooth, Zigbee, or Wi-Fi. As shown in FIG. 1, the radio access point may serve as a common access point for the client device 120 to communicate with both the backroom server 150 and the license server 110.

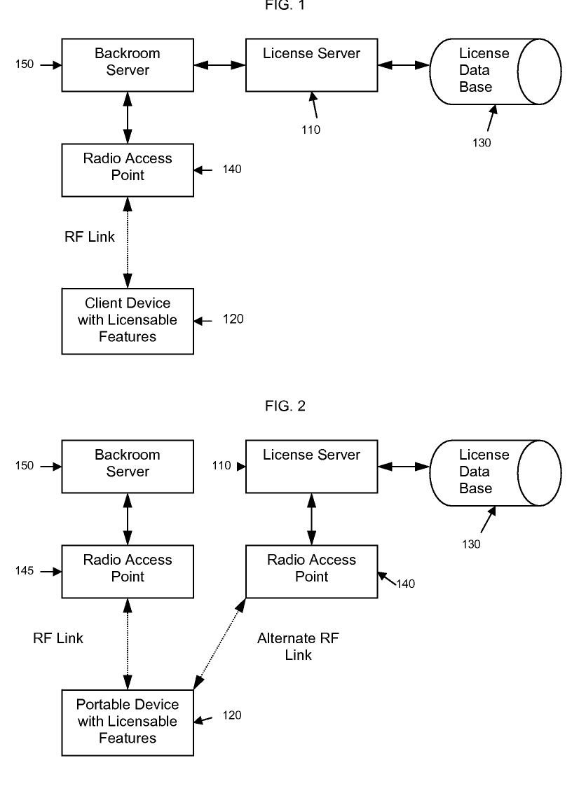

According to other aspects of the invention, as shown in FIG. 2, the client device 120 may communicate with the license server 110 via the radio access point 140, and communicate with the backroom server 150 via another radio access point 145. In some situations, the enterprise operating the license system 100 may not wish to operate the license server 110 on the same network as the backroom server 150, for several reasons. The license server 110 may operate using a different communication technology than the backroom server 150, or the enterprise may have security concerns. In addition, the enterprise may not wish to modify an existing, functioning backroom server system to add the handling of license traffic. The bandwidth for the communication between the client device 120 and the backroom server 150 may not have sufficient capacity to handle additional communications between the client device 120 and the license server 110. In such circumstances, the license server 110 may communicate with the client device 120 via the radio access point 140, and the backroom server 150 may communicate with the client device 120 via the radio access point 145.

The client device 120 includes a plurality of software features 122a, 122b, and 122c (shown in FIG. 4 and collectively referred to as the software features 122), each of which may require a license from the license server 110 in order to operate. After an optional authentication process, the client device 120 transmits a request to the license server 110 via the radio access point 140 for licenses corresponding to the software features 122a, 122b, and/or 122c that the user will require access to. The client device 120 may be any portable device, such as a data collection device (including a portable data terminal (PDT) or barcode scanner), a mobile phone, a personal digital assistant (PDA), or a personal entertainment device.

The user may receive licenses for only those software features that the user will need to use; other software features may not receive licenses, and thus would not be accessible to the user. This enables the same client device to be used by a variety of users. For example, in a workplace environment, an employee would not be required to use the same device each day. Instead, the employee could select any client device available at the beginning of the day. Using the license system 100, the employee can automatically obtain the temporary licenses needed to operate the software features necessary to carry out the employee's duties. No specialized or designated client devices would be required. In a wireless mobile environment like the license system 100, licenses should not be tied to a particular machine, as users may employ different machines day to day or even throughout the course of a single day.

The license database 130 stores licenses obtained by the enterprise deploying the license system 100. Each license enables access to one or more of the software features 122. The license database 130 may store multiple licenses for one of the software features 122. For example, the license database 130 may store five licenses that the enterprise has purchased for the software feature 122a. The license server 110 may then generate up to five temporary licenses for the software feature 122a.

Temporary licenses are generated by the license server 110 for the client device 120. Each temporary license corresponds to one or more licenses stored in the license database 130. The temporary licenses will expire when expiration conditions included in the temporary license are satisfied. Temporary licenses may be generated based on a user ID or a job description. For example, a foreman at a factory may require the use of software features 122a and 122c, while a regular employee may only require the use of the software feature 122a. When the license server 110 receives a request from a foreman, the license server 110 generates one or more temporary licenses corresponding to the software features 122a and 122c. When the license server 110 receives a request from a regular employee, the license server 110 generates a temporary license corresponding to the software feature 122a. The temporary licenses may also be generated on demand, without an accompanying user ID or job description.

The license system 100 is flexible in terms of how the temporary licenses are generated; temporary licenses may be generated based on the criteria in the example above (job function) or on other criteria. In this fashion, users may receive temporary licenses for only the software features the users will require. In addition, the client device 120 may include the criteria (such as user ID or job function) in the request sent to the license server 110. According to other aspects of the invention, the client device 120 may determine the temporary licenses needed and include in the request specific references to the needed temporary licenses.

When the license server 110 receives a request from the client device 120, the license server acquires the corresponding licenses from the license database 130, generates the temporary licenses, and transmits the temporary licenses to the client device 120 to enable access to the corresponding software features. The temporary licenses may be designed to expire after a predetermined time period (such as three hours) or at a predetermined time (such as 5 PM). Additionally, if the user no longer requires a particular software feature, the user could transmit a relinquish message to the license server indicating that the temporary license is no longer required. After a temporary license has expired, the license server 110 makes the license available to other users, and the client device 120 disables access to the software features corresponding to the temporary license. The above expiration conditions are not limiting; other aspects of the present invention may use other types of expiration conditions to determine when the temporary license has expired.

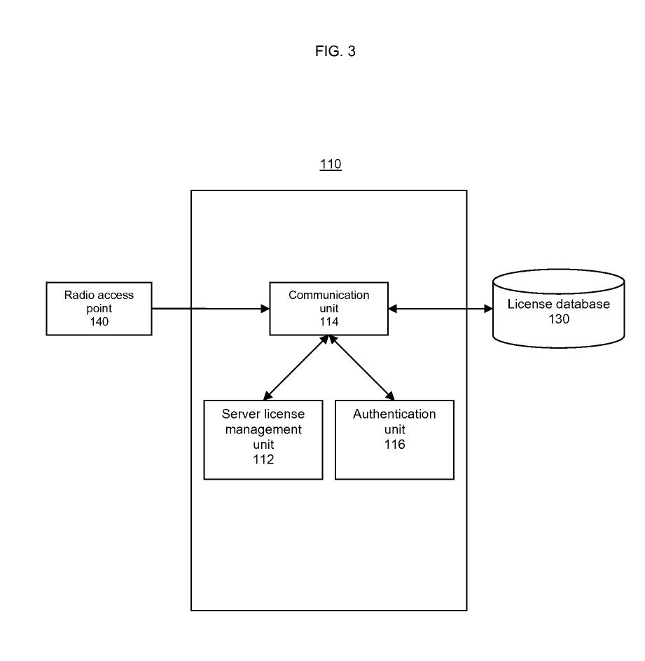

FIG. 3 is a diagram of the license server 110 according to an embodiment of the present invention. The license server 110 includes a communication unit 114, a server license management unit 112, and an authentication unit 116. According to some aspects of the invention, the license server 110 may also include the license database 130. The communication unit 114 communicates with the license database 130, and communicates with the client device 120 via the radio access point 140. Although shown in FIG. 3, the authentication unit 116 is not required, and according to other aspects of the present invention, may be omitted.

The server license management unit 112 manages the licenses stored in the license database 130. When the client device transmits a request to the server license management unit 112 via the radio access point 140 and the communication unit 114, the server license management unit 112 accesses the license database 130 and determines whether the licenses identified in the request are available. If a license identified in the request is not available, the server license management unit may transmit a denial message to the client device 120 indicating that the license is not available.

The license database may store multiple licenses for the software feature 122a. When generating the temporary license, the server license management unit 112 may perform a check-out process to check out one of the multiple licenses. Similarly, a user may not be authorized to use a particular software feature associated with the license. For example, the software feature 122a may have five licenses, so that a maximum of five users may access the software feature 122a at the same time. Once five users have requested a license, no more temporary licenses can be generated until a temporary license generated for one of the five users expires. Alternatively, a feature may be restricted to a particular job function, such as a supervisor; a request for a license from a regular employee would be denied.

If one or more of the requested licenses are available, the server license management unit 112 generates temporary licenses corresponding to the requested licenses for which licenses are available, and transmits the temporary licenses to the client device 120. The server license management unit 112 may then store information indicating that a temporary license has been issued as part of a check-out (or license granting) procedure. The server license management unit 112 generates denial messages for licenses that are not available. Alternatively, if one of the requested licenses is not available, the server license management unit 112 may generate a denial message for all of the requested licenses, even if some licenses are available.

When generating the temporary license, the server license management unit 112 may include an expiration condition indicating when the license will expire. The expiration condition may indicate that the license will expire after a predetermined period of time elapses (such as eight hours) or after a predetermined time of day (such as 5 PM). When the condition specified in the temporary license is satisfied, the client device 120 disables access to the software feature corresponding to the temporary license. In addition, when the expiration condition is satisfied, the server license management unit 112 releases the license for use by other users. The client device 120 and the server license management unit 112 need not communicate with each other in order to release the license; instead, the client device 120 and the server license management unit 112 can release the license independently. If the user of the client device 112 no longer requires the temporary license, the client device may transmit a check-in message indicating that the temporary license is no longer needed. The server license management unit may then release the corresponding license for use by other users, and the client device 120 may disable access to the corresponding software feature.

In a wireless mobile environment such as the license system 100, the client device 120 and the license server 110 are not guaranteed to remain in contact. The separate expiration conditions provide both the client device 120 and the license server 110 with a way to disable the license without further communication with each other, so that a temporary license can be granted to other users.

For example, the software feature 122a may have five associated licenses, so that a maximum of five users may use the software feature 122a at one time. If the client device requests a license for the software feature 122a and four other users are using licenses for software feature 122a, the server license software management unit determines that a license for the software feature 122a is available, checks out the remaining license, and generates a temporary license corresponding to the software feature 122a for the client device 120. Since five users are using the software feature 122a, all of the licenses are checked out and no more temporary licenses for the software feature 122a can be generated. The temporary license may indicate that the temporary license will expire after eight hours. Once the server license management unit 112 determines that the eight hours have elapsed, the server license management unit 112 releases (checks in) one of the licenses corresponding to the software feature 122a. The client device 120 independently disables access to the software feature 122a. The license server 112 need not communicate with the client device 120 during this check-in process.

According to other aspects of the invention, the request from the client device 110 may include a user ID. The server license software unit 112 identifies licenses corresponding to the user ID, and generates the corresponding temporary licenses for the client device 120.

The authentication unit 116 authenticates a user of the client device 120 and/or the license system 100. The authentication unit 116 may authenticate the user as part of a log-in or activation procedure. The authentication may be, for example, a user ID/password, bar code (for example, scanned from a user's badge), voiceprint identification, or biometrics.

FIG. 4 shows the client device 120 according to an embodiment of the present invention. The client device 120 includes the plurality of software features 122a, 122b, and 122c (collectively referred to as the software features 122), a client license management unit 124, a communication unit 128, and a license storage unit 126.

The software features 122 are features of the client device that are enabled through software. The software features 122 may be, for example, a software application, such as a word processor, database, or communication application. The software features 122 may also operate in combination with a particular hardware feature of the client device and realize the functionality of the corresponding hardware feature, such as an image capture program realizing the functionality of a digital camera or barcode scanning application realizing the functionality of a scanner. The software features 122 may also be an individual component of a software application. For example, the client device may have an application to scan different types of barcodes, such as a linear barcode and a 2D barcode. Software feature 122a may be a feature of the application that decodes linear barcodes, and software feature 122b may be a feature of the application that decodes 2D barcodes. The software features 122 may communicate with the backroom server 150 via the communication unit 128 and the radio access point 140 or the radio access point 145.

Each of the software features 122 may require a license from the license server 110 in order to operate, although not all of the software features may require a license. For example, as shown in FIG. 4, the software features 122a and 122c may require a license, but the software feature 122b may not require a license. In this case, the user may operate software feature 122b without first requesting a temporary license from the license server 110. However, in order to operate the software features 122a and 122c, the client device needs to first obtain a temporary license from the license server 110.

The client license management unit 124 manages the temporary licenses received from the license server 110 and generates requests for the temporary licenses. The request for the temporary licenses may be based on the user ID authenticated by the authentication unit 116 or on user input. For example, the client license management unit 124 may generate a request for temporary licenses corresponding to the user, and transmit the request to the license server 110 via the communication unit 128 and the radio access point 140. Alternatively, the authentication unit 116 in the license server 110 may authenticate the user as part of the license request process. The user may instead select a user profile including one or more of the software features 122, and the client license management unit 124 may generate the request for the temporary licenses based on the user profile. The user may also select which of the software features 122 the user will need; the client license management server then generates the request based on the selected software features.

As discussed above, some of the licenses can be reserved for certain levels of employees. For example, if the enterprise has purchased five licenses for the software feature 122c, three may be general licenses available to all employees, one may be reserved for any foreman, and one may be reserved for the CEO. If a request comes in from a worker for the software feature 122c and one of the three general licenses are available, then a license is granted. If none of the three general licenses is available, the request is denied. If a request comes in from a foreman, a license is granted if the foreman license is available. However, if a foreman license is not available but a general license is available, then the request is granted and one of the worker licenses is used to generate the temporary license for the foreman. The foreman's request would be denied only if neither a general license nor the foreman license is available. Finally, if the CEO requests a license, then the license reserved for the CEO is used to generate the temporary license. In this case, since the license is reserved for the CEO and no one else, the license should always be available. Further, as discussed above, a suite of licenses (more than one licenses) may be enabled based on user ID or job function; thus, extending the example given above, when the foreman requests a license, a temporary license for the software feature 122c and the software feature 122b may be generated, while if the worker requests a license, only a temporary license for the software feature 122c is generated.

When generating the request for the temporary licenses, the client license management unit 124 may include expiration conditions in the request specifying when the temporary licenses should expire. These expiration conditions could be based upon user input, although not limited thereto. As described above, the expiration conditions may be a predetermined time (such as 5 PM) or a predetermined time period (such as eight hours). Other aspects of the invention may include different expiration conditions.

The client license management unit 124 may store the temporary licenses received from the license server 110 in the license storage unit 126. The license storage unit 126 may be a separate unit of the client device 120 or may be part of the client license management unit 124. If the client license management unit 124 receives a denial message from the license server 110 indicating that one or more temporary licenses are not available, the client license management unit 124 may control the client device 120 to display the denial message to the user.

Once the temporary licenses are received, the client license management unit 124 applies the temporary licenses to the corresponding software features 122 to enable the user to operate the software features 122. The temporary licenses received from the license server 110 may not contain the same expiration conditions as the request transmitted by the client license management unit 124. For example, the user may have requested a temporary license to operate the software feature 122a for ten hours, but the maximum allowable time is eight hours. In this case, the temporary license transmitted to the client license management unit 124 may include a temporary license allowing the user to operate the software feature 122a for only eight hours. Similarly, the user may request a temporary license for six hours, but the maximum allowable time is eight hours; the temporary license may include the six hour time period specified by the user, or may include the maximum allowable eight hour time period. If the expiration condition has changed, the client license management unit 124 may control the client device 120 to display a message to the user to inform the user of the changed expiration condition.

When the expiration condition of the temporary license is met, the client license management server 124 disables the software features 122 corresponding to the temporary license and deletes the temporary license from the license storage unit 126. The client license management unit 124 need not communicate with the license server 110 during this process. If the expiration period is a predetermined time, such as 5 PM, the client license management unit 124 may consult a real time clock (not shown) provided in the client device 120 to determine whether the predetermined time has passed. The real time clock may be synchronized with a similar real time clock in the license server 110. Synchronizing the real time clock in the client device 120 with the real time clock in the license server 110 will permit the client device 110 to disable the software features 122 at substantially the same time as the license server 110 releases the license for use by other users. A synchronization process to synchronize the real time clock in the client device 120 with the real time clock in the license server 110 may occur during the transmission and receipt of the request and corresponding temporary licenses or at another time.

The real time clock and synchronization processes are optional; the client device 120 may use any technique, such as total elapsed time, to determine when the expiration condition has been satisfied. For example, if the expiration condition is a predetermined time, but the client device 120 is not equipped with a real-time clock, the license server 110 may change the expiration condition to an elapsed time. Thus, if the license is to expire at 5:00 PM, and the current time is 9:00 AM, the license server 120 may issue a temporary license having an expiration condition of 8 hours elapsed time, which would result in the temporary license expiring at the predetermined time of 5:00 PM.

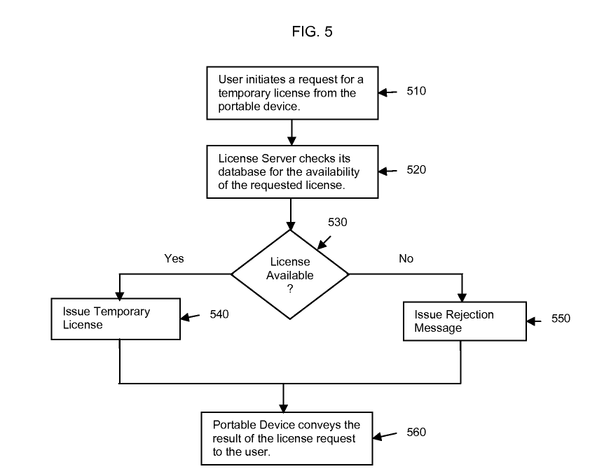

FIG. 5 is a flowchart of a process of requesting a temporary license for the software features 122 according to an embodiment of the present invention. In operation 510, the user requests the client device 120 to obtain one or more temporary licenses. The request could be automatic, based upon the user ID, or could be based on user input. In response to the user request, the client license management unit 124 generates a request for the temporary licenses and transmits the request to the license server 110 via the communication unit 128 and the radio access point 140. The request may include expiration conditions for the temporary licenses. Instead of a request for a specific license or licenses, the request may include a user ID or job function (employee, foreman, manager, etc.) that the license server 110 may use to determine which licenses are needed.

Upon receiving the request, the license server determines whether the requested licenses are available in operation 520. If temporary licenses are available, the license server 110 generates the requested temporary licenses and transmits the temporary licenses to the client device 120 in operation 540. If temporary licenses are not available, the license server 110 transmits a denial message to the client device 120 in operation 550. The request may include criteria for generating temporary licenses, such as a user ID or function, or may include requests for specific temporary licenses.

In operation 560, the client license management unit 124 controls the client device 120 to display the results of the request to the user. If the result was a denial message, the denial message may be displayed. If the result was successful, a message indicating that the result was successful may be displayed. The client license management unit 124 stores any temporary licenses received from the license server 110 in the license storage unit 126, and enables the software features 122 corresponding to the received temporary licenses. Although the client device 120 may still operate without receiving temporary licenses, the user may not be able to operate software features of the client device 120 for which the user has not received temporary licenses. Not all client devices 120 may have a built-in display; some client devices may, for example, have one or more LEDs to relay status conditions to the user. In these cases, the message may be conveyed to the user via the LEDs. Similarly, an audio message, such as a beep, may also be used to convey the granting or denial of the license.

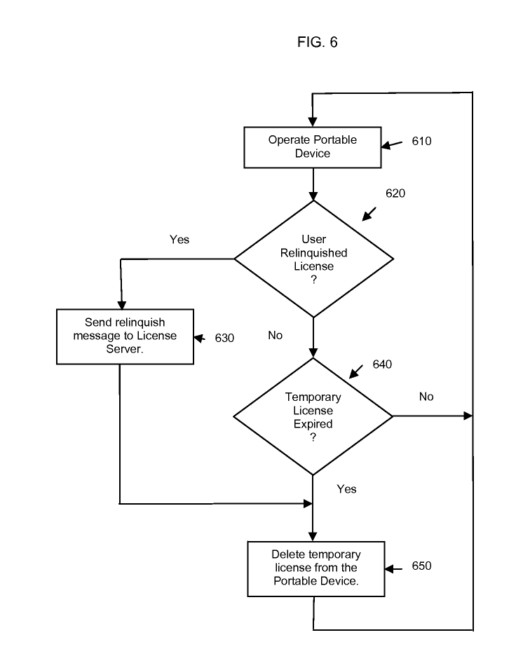

FIG. 6 is a flowchart of a process of deleting a temporary license according to an embodiment of the present invention. In operation 610, the user operates the portable device normally. In operation 620, the client license management unit 124 determines whether the user no longer needs a temporary license stored in the license storage unit 126. For example, if the user determines that he will no longer need to use the software feature 122a, or if the user needs to leave work early due to an appointment or the like, the user can request that the client device 120 relinquish the temporary license corresponding to the software feature 122a. In operation 630, if the user has relinquished one or more temporary licenses, the client license management unit 124 transmits a message to the license server 110 to indicate that the user is relinquishing the temporary license. This may, for example, be part of a shut-down process.

If the user has not relinquished the temporary license, then in operation 640 the client license management unit 124 determines whether the expiration condition of the temporary license has been met. For example, if the expiration condition for the temporary license corresponding to the software feature 122a is eight hours of use, and the client device received the temporary license eight hours ago, the client license management server 124 determines that the expiration condition has been met. If the expiration condition has not been met, then the process returns to operation 610 and the client device 120 operates normally.

In operation 650, the client license management unit 124 deletes the temporary license stored in the license storage unit 126, and disables operation of the corresponding software feature, such as the software feature 122a. At about the same time, the license server 110 releases the license stored in the license database 130 corresponding to the temporary license for use by other users. The license server 110 and the client device 120 may perform operation 650 independently or in communication with one another. The license server 110 and the client device 120 may not perform operation 650 at exactly the same time, and thus there may be an overlap period in which the license server 110 has released the license, but the client device 120 has not, or vice versa.

Aspects of the present invention can also be embodied as computer readable codes on a computer readable recording medium. The computer readable recording medium is any data storage device that can store data which can be thereafter read by a computer system. Examples of the computer readable recording medium also include read-only memory (ROM), random-access memory (RAM), CDs, DVDs, magnetic tapes, floppy disks, and optical data storage devices. Aspects of the present invention may also be embodied as carrier waves (such as data transmission through the Internet). The computer readable recording medium can also be distributed over network coupled computer systems so that the computer readable code is stored and executed in a distributed fashion. Also, functional programs, codes, and code segments for accomplishing the present invention can be easily construed by programmers skilled in the art to which the present invention pertains.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A license management system comprising:
a license server to store and manage at least one license, each license corresponding to one or more software features; and
a portable client device to request at least one temporary license from the server, each temporary license corresponding to one or more of the at least one license, so as to enable operation of the corresponding one or more software features installed on the portable client device;
wherein each temporary license includes an expiration condition defining conditions under which the temporary license will expire.

2. The system of claim 1, wherein the expiration condition is a predetermined time or a predetermined time period.

3. The system of claim 1, further comprising a backroom server to perform predetermined operations in communication with at least one of the one or more software features installed on the portable client device.

4. The system of claim 1, further comprising:
a first radio access point to communicate data between the license server and the portable client device; and
a second radio access point to communicate data between the portable client device and a backroom server.

5. The system of claim 4, wherein the request includes a user ID.

6. The system of claim 5, wherein:
when the license server determines that the expiration condition is satisfied, the license server releases the corresponding at least one license for use by other client devices, without communicating with the client device; and
when the client device determines that the expiration condition is satisfied, the client device disables access to the corresponding one or more software features, without communicating with the license server.

7. The system of claim 1, further comprising:
a license database to store the at least one license;
wherein the license server generates the at least one temporary license based on a corresponding license in the license database.

8. The system of claim 1, wherein:
the license server comprises a first real time clock, and the license server determines when the expiration condition is satisfied based on the real time clock without communicating with the portable client device;
the portable client device comprises a second real time clock, and the portable client device determines when the expiration condition is satisfied based on the second real time clock without communicating with the license server; and
the license server and the portable client device perform a synchronization operation to synchronize the first real time clock and the second real time clock.

9. The system of claim 8, wherein the license server and the portable client device perform the synchronization operation while transmitting the request and transmitting the at least one temporary license.

10. The system of claim 1, wherein the request includes a proposed expiration condition for the temporary license.

11. A license server comprising:
a communication unit; and
a license management unit to receive a request from a portable client device for at least one temporary license, each temporary license corresponding to at least one license that enables a corresponding software feature of the portable client device, to determine if the at least one license is available, to generate the at least one temporary license if the at least one license is available, and to transmit the at least one temporary license to the portable client device via the communication unit;
wherein each temporary license comprises an expiration condition specifying when the temporary license expires.

12. The license server of claim 11, wherein the expiration condition is a predetermined time or a predetermined time period.

13. The license server of claim 11, wherein, when the license management unit determines that an expiration condition of one of the at least one temporary license is satisfied, the license management unit releases the at least one license corresponding to the temporary license for use by other client devices, without communicating with the client device.

14. The license server of claim 11, wherein:
when the license management unit transmits the at least one temporary license, the license management unit stores information indicating that the at least one temporary license has been transmitted; and
when the expiration condition is satisfied, the license management unit deletes the stored information so as to allow another portable client device to receive the at least one temporary license.

15. The license server of claim 11, wherein the license server accesses a license database to determine whether the at least one license is available.

16. The license server of claim 11, wherein the request includes a user ID, and the license management unit determines whether the at least one license is available and generates the at least one temporary license based on the user ID.

17. The license server of claim 11, wherein, when the license management unit determines that the expiration condition of one of the at least one temporary license has expired, the license management unit releases a corresponding license for use by other client devices.

18. The license server of claim 17, further comprising:
a real time clock;
wherein the license server determines whether the expiration condition of the at least one temporary license is satisfied based on the real time clock, and performs a synchronization operation with the portable client device to synchronize the real time clock.

19. A portable client device comprising:
a communication unit;
at least one software feature, each requiring a license in order to operate;
a license storage unit to store at least one temporary license, each enabling operation of one or more of the at least one software feature;
a license management unit to generate a request for the at least one temporary license, to receive the at least one temporary license from a license server, and to enable the at least one software feature corresponding to the at least one temporary license;
wherein each temporary license includes an expiration condition specifying when the temporary license expires.

20. The portable client device of claim 19, further comprising:
an authentication unit to authenticate a user of the portable client device;
wherein the license management unit generates the request based on a user ID of the user authenticated by the authentication unit.

21. The portable client device of claim 20, wherein the request includes a user ID of a user.

22. The portable client device of claim 19, wherein the expiration condition is a predetermined time or a predetermined time period.

23. The portable client device of claim 19, wherein, when the expiration condition is satisfied, the license management unit deletes the corresponding temporary license from the license storage unit and disables operation of the corresponding at least one software feature, without communicating with the license server.

24. The portable client device of claim 23, further comprising:
a real time clock;
wherein the license management unit determines whether the expiration condition is satisfied based on the real time clock, and performs a synchronization operation with the license server to synchronize the real time clock with the license server.

25. The portable client device of claim 19, wherein, when the license management unit receives a request from the user to delete one of the at least one temporary license, the license management unit deletes the temporary license from the license storage unit, disables operation of the corresponding at least one software feature, and transmits a request to the license server to indicate that the temporary license is no longer required.

26. A method of generating a temporary license for a portable client device, comprising:
receiving a request for a temporary license from a portable client device;
determining whether a temporary license is available;
generating the temporary license if the temporary license is available; and
transmitting the temporary license to the portable client device;
wherein the temporary license includes an expiration condition specifying when the temporary license expires.

27. The method of claim 26, further comprising:
transmitting a denial message to the portable client device if the temporary license is determined to be unavailable.

28. A computer readable medium comprising instructions that, when executed by a computer, cause the computer to perform the method of claim 26.

29. A method of disabling a temporary license when an expiration condition of the temporary license has expired, the method comprising:
determining whether the expiration condition of the temporary license is satisfied, the temporary license enabling operation of at least one software feature of a portable client device; and
if the expiration condition of the temporary license is satisfied, deleting the temporary license from the portable client device and disabling operation of the at least one software feature;
wherein the deleting of the temporary license and the disabling of the operation occurs independently of a license server.

30. The method of claim 29, wherein the expiration condition is a predetermined time or a predetermined time period.

31. A computer readable medium comprising instructions that, when executed by a computer, cause the computer to perform the method of claim 29.
